(19) United States
(12) Patent Application Publication
(10) Pub. No.: US 2013/0070342 A1
(43) Pub. Date: Mar. 21, 2013

(54) DISPLAY SCREEN MASK STRUCTURE AND MANUFACTURING METHOD THEREOF

(71) Applicants: Rih-Yang Wang, Taichung City (TW); Po-Tang Wang, Taichung City (TW); Yuan-Hsing Ko, Taichung City (TW); Shu-Hui Chang, Taichung City (TW)

(72) Inventors: Rih-Yang Wang, Taichung City (TW); Po-Tang Wang, Taichung City (TW); Yuan-Hsing Ko, Taichung City (TW); Shu-Hui Chang, Taichung City (TW)

(21) Appl. No.: 13/353,522

(22) Filed: Jan. 19, 2012

(30) Foreign Application Priority Data
Sep. 21, 2011 (TW) 100133863

(51) Int. Cl. G02B 1/11; B32B 38/10; B32B 37/14; B32B 37/02; B32B 37/12

(52) U.S. Cl. 359/609; 156/250

(57) ABSTRACT

The present invention is related to a display screen mask structure, providing a plurality of arranged and combined substrate units overlapped on a self-light emitting display element of a photoelectric device panel. The light, radiated from the self-light emitting display element, is filtered and reflected by and concentratedly radiated from a light-reflecting layer overlapped on the light-transmitting bodies of the substrate units, so that the light leakage can be prevented and an external strong light can be shielded by the light-shielding layer overlapped on the light-reflecting layer, the light generated from the self-light emitting display element can be efficiently concentrated, and the phenomenon such as whitening and low image contrast ratio occurred by an external light radiating on a display panel can be improved.

### BACKGROUND OF THE INVENTION

1. Field of the Invention

The present invention relates to a display screen mask structure and a manufacturing method thereof, and in particular relates to a related technical skill applied for a photoelectric display device.

2. Description of the Related Art

Evaporation methods are often utilized to manufacture filtering structures of conventional photoelectric device panels. The photoelectric device panel includes a self-light emitting display element having a thin film multilayer structure, a substrate plate disposed on one side of the self-light emitting display element, and a metallic-pattern molded shielding plate disposed on another side of the substrate plate. In the film-forming manufacturing process of the evaporation method, the vaporization material is attachingly combined to the substrate plate through the metallic-pattern molded shielding plate, and thus the metallic-pattern molded shielding plate overlapped on the surface of the substrate plate can be utilized to shield the light. Moreover, conventional masks and exterior antiglare films can be additionally utilized to enhance the display lights, but there still have some following problems of this conventional filtering structure occurred in the actual application.

Firstly, when the conventional displayer is radiated by an outdoor strong light, the intensity ratio of between the light being refracted from the display screen and the light being radiated on the display screen, 180 Lux/40000×0.8 Lux≈0.005625 [polarizer cross-section coefficient multiplied by the coefficient of vertical cross-section of polarizer reflecting the external strong light] presents that the contrast ratio of the display screen is very small, and the light transmitted intensity is only ⅕ left when further adding the conventional polarizer, and there has a large difference when comparing to the indoor visual acuity, 180 Lux/300 Lux˜0.6. Moreover, when the display has an increased light intensity corresponding to that of the external strong light, the RGB colors of the displayer is easily fugitive and can only be sustained for about one to two years. Thus, the display result of this conventional filtering structure is worse while being illuminated by the external strong light.

Secondly, although this filtering structure using for general displayers can have a better shielding effect, the mask having a large-size protruded structure is still required to be supported or foldably received. Thus, the usability of this conventional filtering structure is imperfect. For example, Taiwan Patent No. 1337238 discloses a general digital camera provided with a conventional foldable single mask.

Thirdly, if the antiglare films additionally utilized in the conventional filtering structure, the total light transmittance rate is reduced by the antiglare film, and all of the display screen is whiten when an outdoor sunlight directly radiates on the display screen. Thus, the light transmittance rate of this conventional filtering structure is low.

Fourthly, a larger metallic-pattern molded shielding plate is required when a larger panel is manufactured by the evaporation method. However, the large metallic-pattern molded shielding plate is centrally sank by the gravity thereof so that the accuracy of the film pattern overlapped on the surface of the substrate plate is decreased, thus limiting the dimensional workability.

Fifthly, due to a high thermal expansion rate of the metallic-pattern molded shielding plate, the pattern of the metallic-pattern molded shielding plate is tended to be shifted when the evaporation method is applied, thus increasing the processing difficulty.

### BRIEF SUMMARY OF THE INVENTION

In view of the conventional photoelectric device panel having a very small contrast ratio measured between the light transmitted intensity displayed on the polarizer microstructure under outdoor strong light and the light reflected from the vertical area of the polarizer microstructure when radiating on the display screen, limited dimensional workability and high difficulty in manufacturing process, the present invention provide a display screen mask structure and a manufacturing method thereof to overcome these inconveniences.

The main purpose of the present invention is to provide a display screen mask structure and a manufacturing method thereof. The display screen mask structure comprises a plurality of substrate units and a plurality of combining units. The combining units comprises black light-absorbing adhesive bodies, the substrate units are sequentially and diffusively arranged and adhesively combined to each other by the black light-absorbing adhesive bodies of the combining units, and the substrate units which are arranged and combined to each other are overlapped on a self-light emitting display element of a photoelectric device panel. The light, radiated from the self-light emitting display element, is filtered and reflected by and concentratedly radiated from the light-reflecting layer overlapped outside the light-transmitting bodies of the substrate units, and the light leakage can be prevented and an external strong light can be effectively shielded by the light-shielding layer overlapped on the light-reflecting layer, so that the light generated from the self-light emitting display element can be more efficiently concentrated, and the image contrast ratio of the display screen under the external light can be increased. Further, the display screen mask structure has a simple configuration suitable for the different sizes of photoelectric device panels and various fields, capable of reducing the total manufacturing cost and simplifying the manufacturing process.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective schematic view showing a combination status of a display screen mask structure of the present invention;

FIG. 2 is a partially-enlarged perspective schematic view of the display screen mask structure of the present invention;

FIG. 3 is a partially-enlarged top schematic view of the present invention;

FIG. 4 is a reference view showing a first working status of a display screen mask structure of the present invention;

FIG. 5 is a reference view showing a second working status of a display screen mask structure of the present invention;

FIG. 6 is a schematic view showing a processing status of the display screen mask structure of the present invention;

FIG. 7 is a perspective reference view showing a combination status of a display screen mask structure of a first embodiment of the present invention;

FIG. 8 is a partially-enlarged perspective reference view of the display screen mask structure of the first embodiment of the present invention;

FIG. 9 is a perspective reference view showing a combination status of a display screen mask structure of a second embodiment of the present invention;

FIG. 10 is a partially top reference view of the display screen mask structure of the second embodiment of the present invention; and

FIG. 11 is a perspective reference view showing a combination status of a display screen mask structure of a third embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

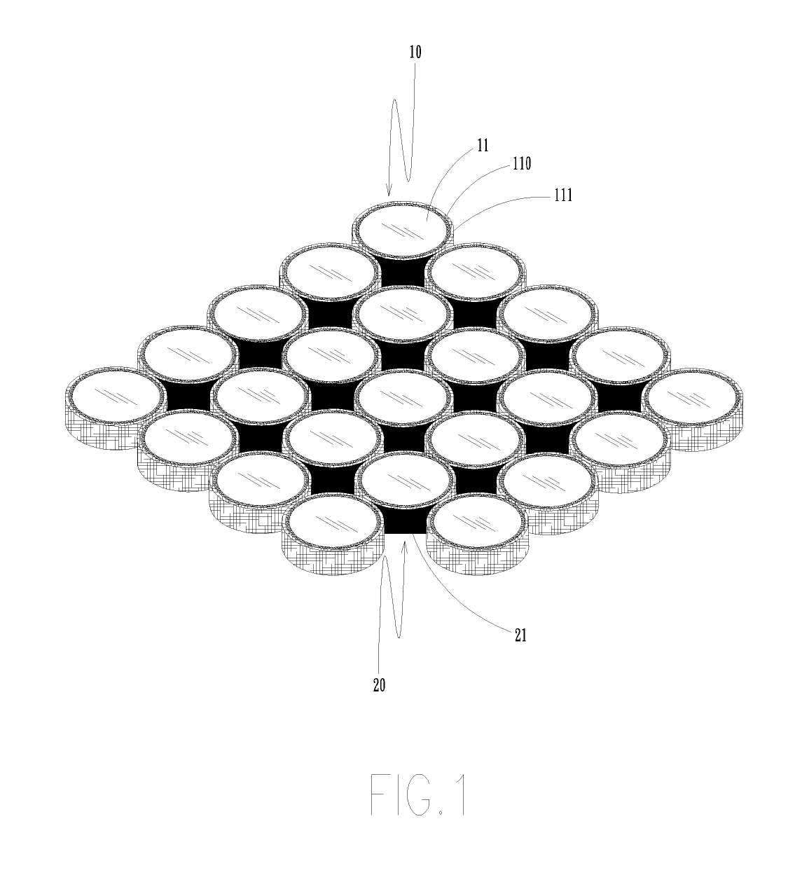

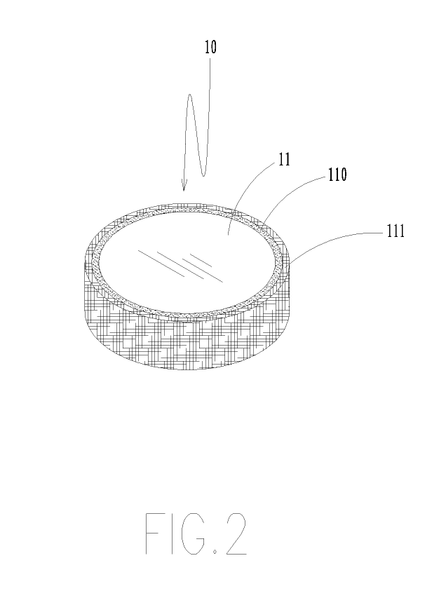

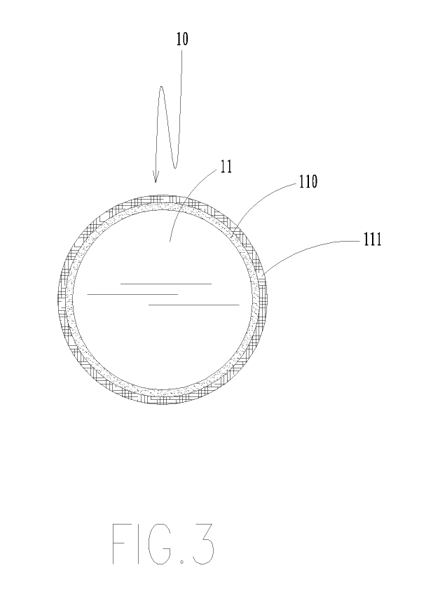

Referring to FIGS. 1, 2 and 3, FIG. 1 is a perspective schematic view showing a combination status of a display screen mask structure of the present invention, FIG. 2 is a partially-enlarged perspective schematic view of the present invention, and FIG. 3 is a partially-enlarged top schematic view of the present invention. The display screen mask structure comprises a plurality of substrate units 10 and a plurality of combining units 20.

The substrate unit 10 comprises a plurality of light-transmitting bodies 11 and a bottom side, wherein an outer side edge of the light-transmitting body 11 is overlapped with a light-reflecting layer 110, the light-reflecting layer 110 is outwardly overlapped with a light-shielding layer 111, and the bottom side of substrate unit 10 is disposed with an adhesive layer (not shown in FIGs.). In this embodiment, the light-transmitting body 11 is constituted by an optical fiber made of silicon dioxide (glass) material, polymethyl methacrylate (acrylic) material, or plastic material. Further, the light-transmitting body 11 is formed as a circle shape or other shapes based on the shape change of TFT, RGB or RGBY. The light-transmitting bodies 11 of the substrate unit 10 comprise surfaces formed as inwardly-recessed arc shapes and presented with yellow light-transmitting feature.

The combining unit 20 comprises a plurality of black light-absorbing adhesive bodies 21, and the substrate units 10 are sequentially and diffusively arranged and adhesively combined to each other by the black light-absorbing adhesive bodies 21 of the combining units 20.

The display screen mask structure of the present invention is assembled by the above-described components.

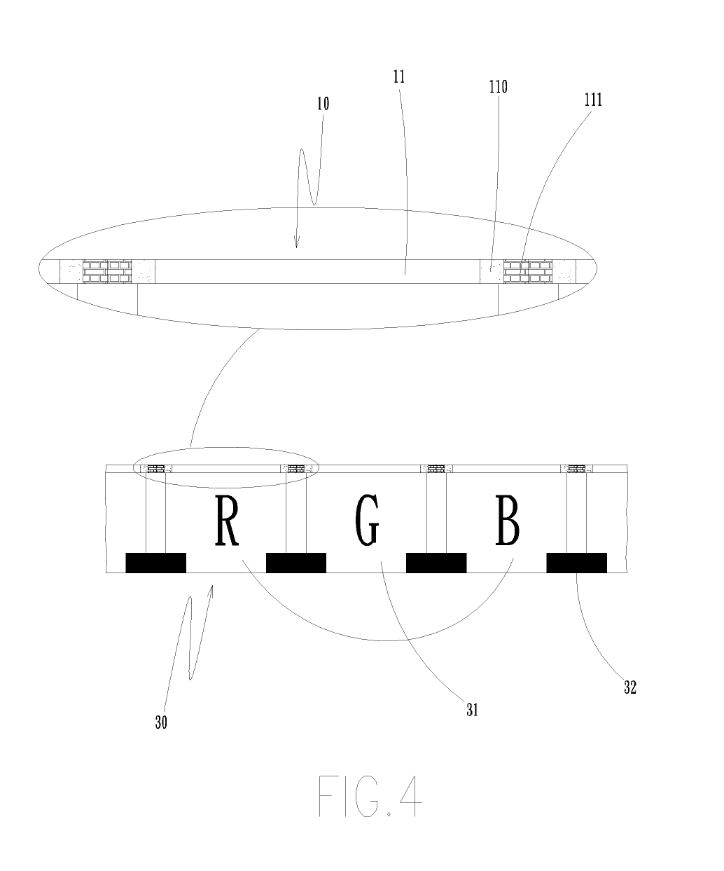

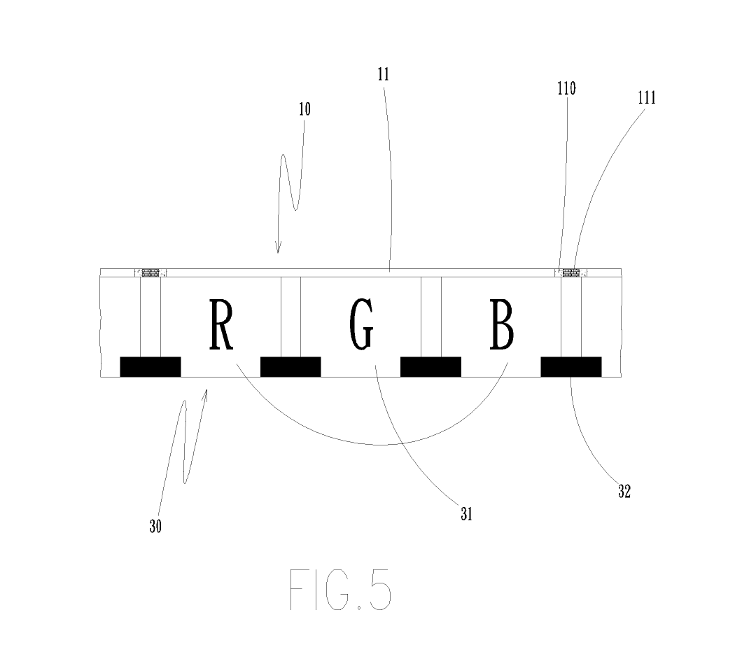

FIGS. 4 and 5 are reference views showing a first working status and a second working status of the display screen mask structure of the present invention. The substrate units 10 are sequentially and diffusively arranged and adhesively combined to each other by the black light-absorbing adhesive bodies 21 of the combining units 20, and the substrate units 10 which are arranged and combined to each other are overlapped on a self-light emitting display element 30 of a photoelectric device panel. The light-transmitting body 11 of the substrate units 10 are corresponding to the light-emitting unit RGB, RGBY or R+G+B, R+G+B+Y of R/G/B light source display modules 31 of the self-light emitting display element 30, and the combining units 20 utilized to combine the substrate units 10 are corresponding to a black matrix 32 of the self-light emitting display element 30. The light, radiated from the self-light emitting display element 30, is filtered and reflected by and concentratedly radiated from the light-reflecting layer 110 overlapped outside the light-transmitting bodies 11 of the substrate units 10, and the emitted light is shield by the light-shielding layer 111 disposed outside the light-reflecting layer 110. Thus, the light can be prevented from being scattered, the light can be effectively shielded, the luminance of a large-area reflective surface formed on the vertical surface of the displaying surface of the polarizer microstructure radiated by an external strong light can be reduced, and the light generated from the self-light emitting display element 30 can be more efficiently concentrated and the image brightness and contrast ratio can be enhanced. Further, the display screen mask structure of the present invention has a simple configuration suitable for the different sizes of photoelectric device panels and various fields, reducing the total manufacturing cost, and simplifying the manufacturing process.

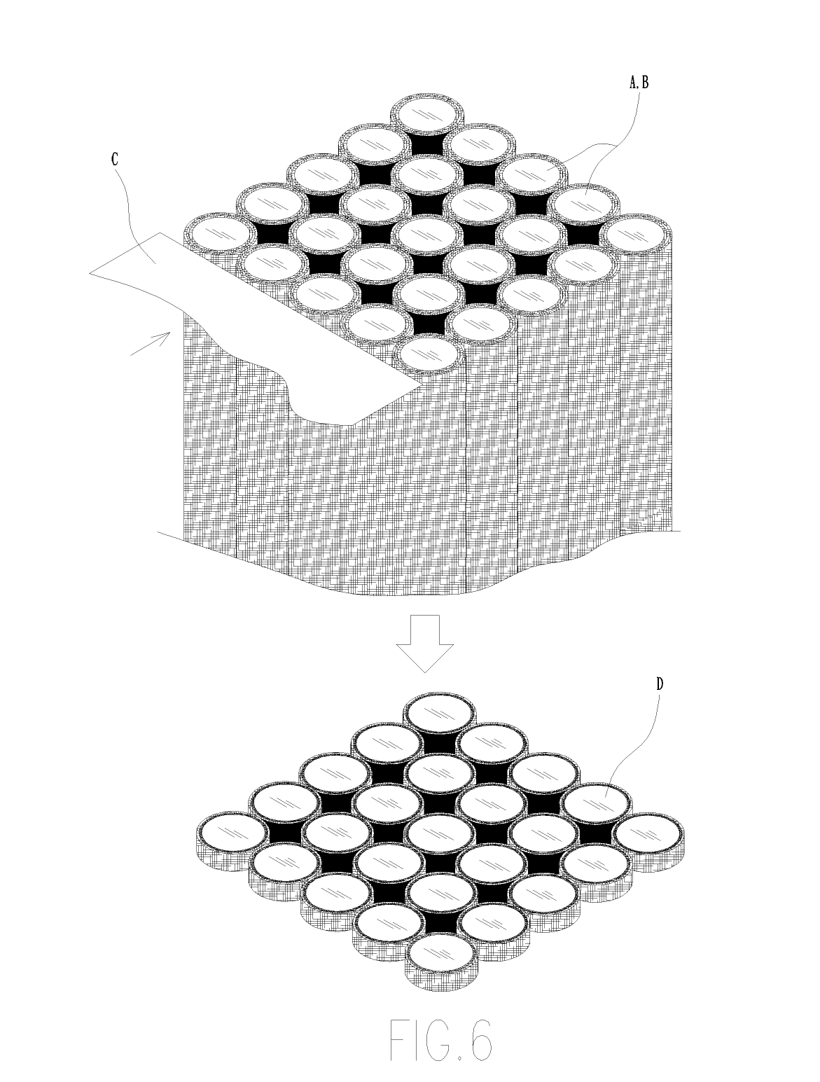

FIG. 6 is a schematic view showing a processing status of the display screen mask structure of the present invention. A method for manufacturing a display screen mask structure of the present invention comprises the following steps:

(A) in a substrate material processing step, a light-reflecting coating is covered on an outer side of an optical fiber rod and covering a shielding coating on an outside of the light-reflecting coating;

(B) in a bundle processing step, the optical fiber rods are sequentially and diffusively arranged in the substrate material processing step and filling a black light-absorbing adhesive body of a combining units in between the optical fiber rods, thereby forming a high light-absorbing surface on a displaying surface and causing the optical fiber rods to be mutually and fixedly combined into an optical fiber bundle in a desired area;

(C) in a cutting processing step, the optical fiber bundle is laterally cut in accordance with a desired thickness by a cutting device; and

(D) in a thin film mask product step, the optical fiber bundles is formed in the cutting processing step into a thin film mask product of large-area sheet material.

By providing the display screen mask structure to be overlapped on the self-light emitting display element 30 of the photoelectric device panel according to the above-described manufacturing process, the self-light emitting display element 30 is effectively shielded for preventing the light leakage, and the light generated from the self-light emitting display element 30 can be efficiently concentrated and the image brightness and contrast ratio can be enhanced.

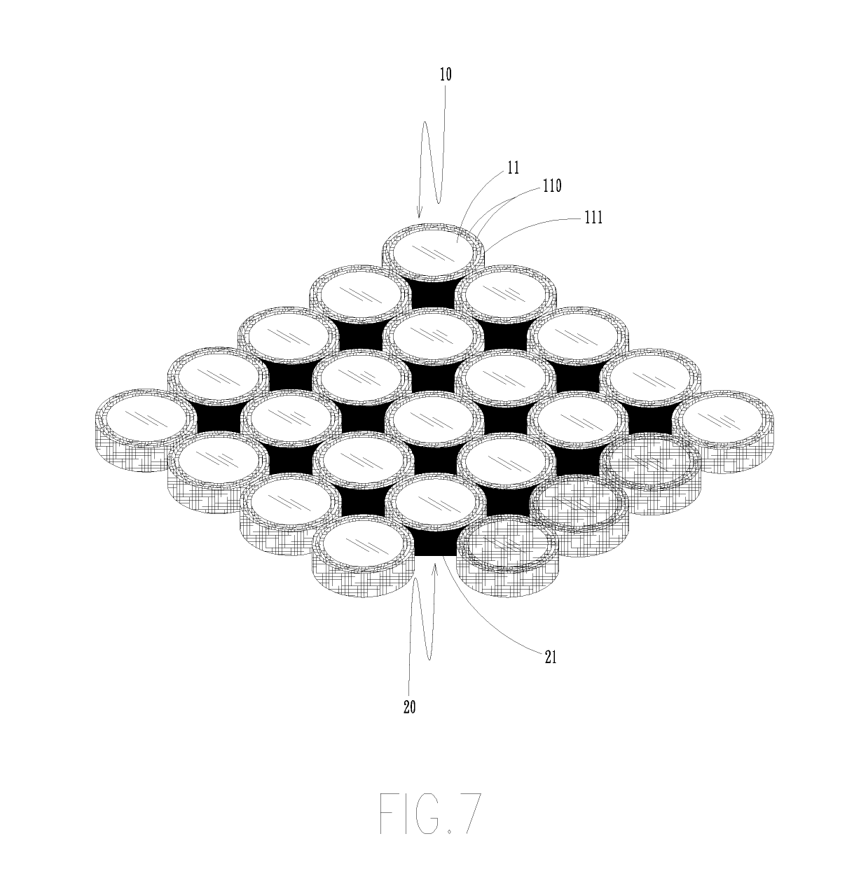

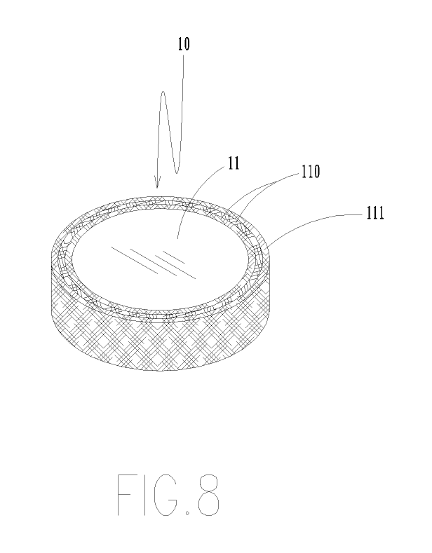

FIG. 7 is a perspective reference view showing a combination status of a display screen mask structure of a first embodiment of the present invention, and FIG. 8 is a partially-enlarged perspective reference view of the display screen mask structure of the first embodiment of the present invention. The entire structure of the display screen mask structure of the first embodiment of in FIGS. 7 and 8 differs from that in FIGS. 1, 2 and 3 in that the outer side edge of the light-transmitting body 11 is overlapped with a plurality of light-reflecting layers 110, and the light-reflecting layer 110 is outwardly overlapped with a light-shielding layer 111, so that the entire light generated therefrom can be efficiently concentrated and the present invention can be provided with multiple utilities.

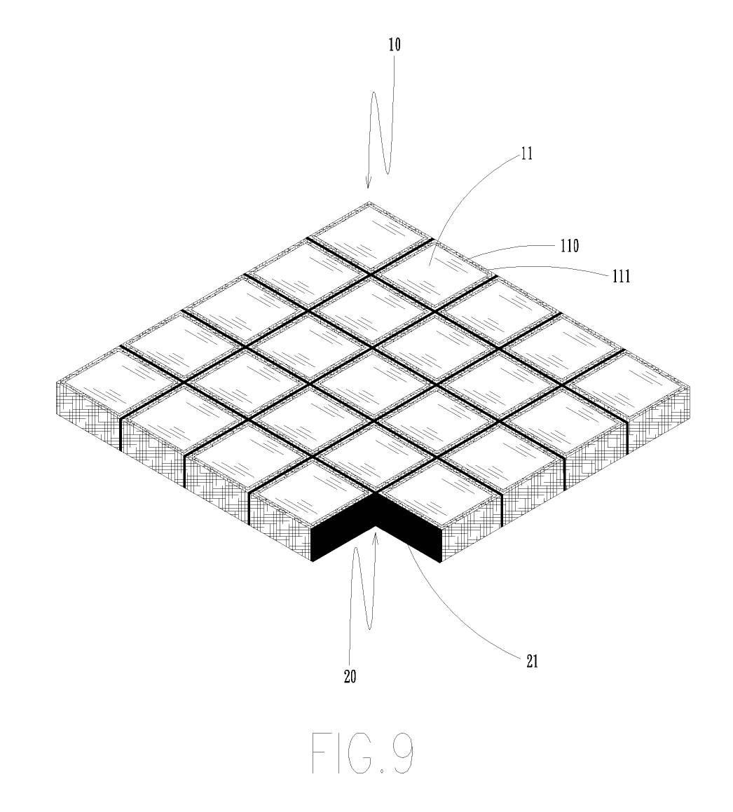

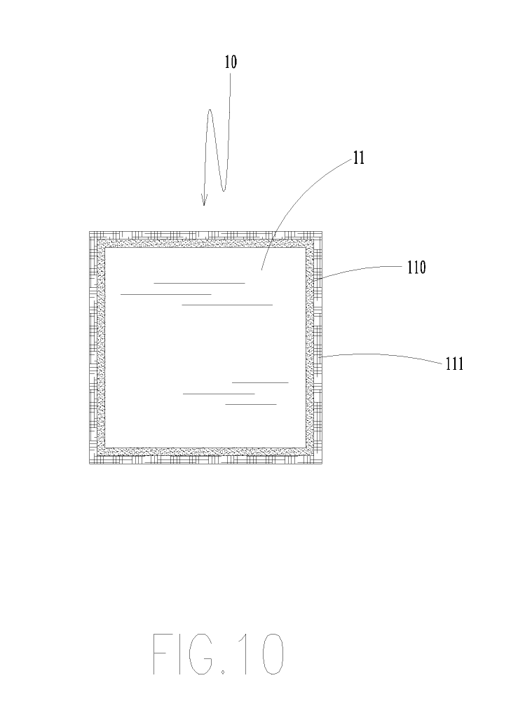

FIG. 9 is a perspective reference view showing a combination status of a display screen mask structure of a second embodiment of the present invention, and FIG. 10 is a partially top reference view of the display screen mask structure of the second embodiment of the present invention. The entire structure of the display screen mask structure of the second embodiment of in FIGS. 9 and 10 differs from that in FIGS. 1, 2 and 3 in that the light-transmitting bodies 11 of the substrate unit 10 are formed as square shapes corresponding to the light-emitting unit RGB, RGBY or R+G+B, R+G+B+Y of R, G, B or Y light source display module 31 of the self-light emitting display element 30, the square light-transmitting body 11 of the substrate unit 10 is overlapped with at least one light-reflecting layer 110, and the light-reflecting layer 110 is outwardly overlapped with a light-shielding layer 111, so that the entire light generated therefrom can be efficiently concentrated and the present invention can be provided with multiple utilities.

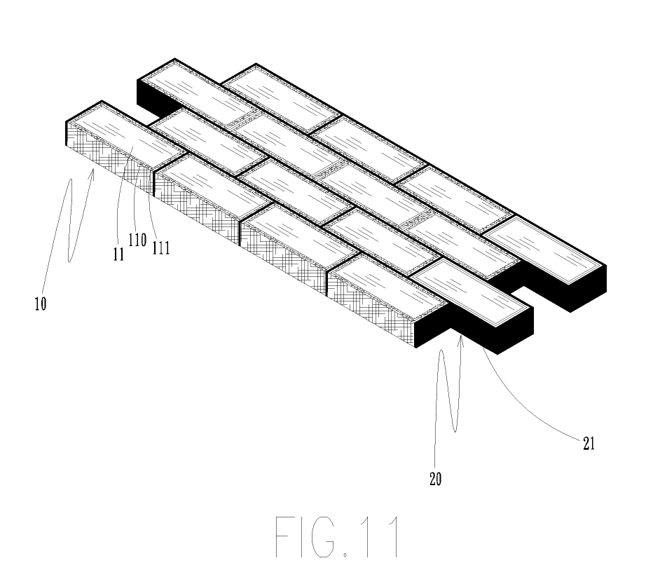

FIG. 11 is a perspective reference view showing a combination status of a display screen mask structure of a third embodiment of the present invention. The entire structure of the display screen mask structure of the third embodiment of in FIG. 11 differs from that in FIGS. 1, 2 and 3 in that the light-transmitting bodies 11 of the substrate unit 10 are formed as rectangular shapes, which are alternatively arranged in brick pattern and corresponding to the light-emitting unit RGB, RGBY or R+G+B, R+G+B+Y of R, G, B or Y light source display module 31 of the self-light emitting display element 30, the rectangular light-transmitting body 11 of the substrate unit 10 is overlapped with at least one light-reflecting layer 110, and the light-reflecting layer 110 is outwardly overlapped with a light-shielding layer 111, so that the entire light generated therefrom can be efficiently concentrated and the present invention can be provided with multiple utilities.

The advantages of the display screen mask structure of the present invention are described as follows.

First of all, in the display screen mask structure of the present invention, the thin film mask arranged and combined by the substrate units is overlapped on the self-light emitting display element of the photoelectric device panel, and the thin film mask can be dimensionally extended or expanded to be applied to different sizes of photoelectric device panels and in various fields, such as large-sized or small-sized photoelectric device panel.

Further, in the display screen mask structure of the present invention, the thin film mask arranged and combined by the substrate units is overlapped on the self-light emitting display element of the photoelectric device panel, the light-transmitting bodies of the substrate unit are corresponding to the light-emitting unit of R, G, B or Y light source display module of the self-light emitting display element, and the combining units utilized to combine the substrate units are corresponding to a black matrix 32 of the self-light emitting display element, so that the structural configuration and the manufacturing process can be simplified.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display screen mask structure, comprising:
a plurality of substrate units comprising light-transmitting bodies, the light-transmitting body including an outer side edge overlapped with at least one light-reflecting layer, and the light-reflecting layer outwardly overlapped with at least one light-shielding layer; and
a plurality of combining units comprising black light-absorbing adhesive bodies, the substrate units sequentially and diffusively arranged and adhesively combined to each other by the black light-absorbing adhesive bodies of the combining units.

2. The display screen mask structure as claimed in claim 1, wherein the light-transmitting body comprises an optical fiber made of silicon dioxide or glass material.

3. The display screen mask structure as claimed in claim 1, wherein the light-transmitting body comprises an optical fiber made of polymethyl methacrylate or acrylic material.

4. The display screen mask structure as claimed in claim 1, wherein the light-transmitting body comprises an optical fiber made of plastic material.

5. The display screen mask structure as claimed in claim 1, wherein the light-transmitting body comprises a circle shape.

6. The display screen mask structure as claimed in claim 1, wherein the light-transmitting body comprises a square shape.

7. The display screen mask structure as claimed in claim 1, wherein the light-transmitting bodies of the substrate units alternatively arranged in brick pattern comprise rectangular shapes.

8. The display screen mask structure as claimed in claim 1, wherein the outer side edge of the light-transmitting body is overlapped with a plurality of light-reflecting layers.

9. The display screen mask structure as claimed in claim 1, wherein the light-reflecting layer comprises a white coloration.

10. The display screen mask structure as claimed in claim 1, wherein the light-reflecting layer comprises a silver coloration.

11. The display screen mask structure as claimed in claim 1, wherein the substrate unit comprises a bottom side disposed with an adhesive layer.

12. The display screen mask structure as claimed in claim 1, wherein the light-transmitting bodies of the substrate unit comprise surfaces formed as inwardly-recessed arc shapes.

13. The display screen mask structure as claimed in claim 1, wherein the light-transmitting bodies of the substrate unit comprise yellow light-transmitting feature.

14. A method for manufacturing a display screen mask structure, comprising:
covering a light-reflecting coating on an outer side of an optical fiber rod and covering a shielding coating on an outside of the light-reflecting coating in a substrate material processing step;
sequentially and diffusively arranging the optical fiber rods in the substrate material processing step and filling a black light-absorbing adhesive body of a combining units in between the optical fiber rods in a bundle processing step to form a high light-absorbing surface on a displaying surface and to cause the optical fiber rods to be mutually and fixedly combined into an optical fiber bundle in a desired area;
laterally cutting the optical fiber bundle in accordance with a desired thickness by a cutting device in a cutting processing step; and
forming the optical fiber bundles in the cutting processing step into a thin film mask product of large-area sheet material.

15. The method for manufacturing the display screen mask structure as claimed in claim 14, wherein the light-reflecting coating covered on the outer side of the optical fiber rod in the substrate material processing step comprises a high-reflective a white coloration.

16. The method for manufacturing the display screen mask structure as claimed in claim 14, wherein the light-reflecting coating covered on the outer side of the optical fiber rod in the substrate material processing step comprises a silver coloration.

17. The method for manufacturing the display screen mask structure as claimed in claim 14, wherein the shielding coating covered on the outside of the light-reflecting coating covered on the outer side of the optical fiber rod in the substrate material processing step comprises a black coloration.
